(19) United States
(12) Patent Application Publication
(10) Pub. No.: US 2014/0188663 A1
(43) Pub. Date: Jul. 3, 2014

(54) STOCK NOTIFIERS ON SHELVES

(71) Applicants: Richard Neil Cancro, Portland, OR (US); Joel Bennett Acker, JR., Brush Prairie, WA (US); Douglas James Pedley, Portland, OR (US)

(72) Inventors: Richard Neil Cancro, Portland, OR (US); Joel Bennett Acker, JR., Brush Prairie, WA (US); Douglas James Pedley, Portland, OR (US)

(73) Assignee: Wal-Mart Stores, Inc., Bentonville, AR (US)

(21) Appl. No.: 13/730,368

(22) Filed: Dec. 28, 2012

(51) Int. Cl. G06Q 30/06

(52) U.S. Cl. CPC G06Q 30/0601; G06Q 30/0623
USPC 705/26.61; 705/26.1; 705/26.9; 705/27.1

(57) ABSTRACT

A method for sending notifications from a notification server to a mobile computing device to a user includes obtaining, at a processing device of the notification server, a request including user request information to notify the user when a product offered for sale by a retailer becomes available in a facility of the retailer when the mobile computing device scans a notification image. The user request information includes an item identifier corresponding to the product, facility information corresponding to the facility, and a user identifier corresponding to the user. When the product becomes available within the facility, the processing device retrieves the user request information from a user request database and generates a notification based on the user request information. The processing device transmits the generated notification to the mobile computing device.

### BACKGROUND INFORMATION

1. Field of the Disclosure

The present invention relates generally to systems and methods for sending a notification to a mobile computing device corresponding to a user. In particular, examples of the present invention are related to techniques for generating a notification based on user request information to notify a user when an item offered for sale by a retailer becomes available within a facility of the retailer.

2. Background

Shoppers often enter a shopping facility in search of one or more products offered for sale within the facility. Often, the shopper may come to a specific shopping facility in response to an advertisement or a promotion offered by the facility related to a particular product the shopper wants to purchase. For instance, during back-to-school events, the shopping facilities may offer promotions on back-to-school products. Due to a high-demand, the particular product the shopper wants to purchase may be temporarily sold out. In this scenario, the shopper will often leave the shopping facility in search of the particular product elsewhere.

It is known, for a shopper to go to a service desk within a department of the facility and request that a facility attendant reorder the product that is currently sold-out. One drawback of requesting a particular product be reordered, is that it is a hassle for a shopper who is in a rush to take the time to find a facility attendant at a service desk to make the request. Additionally, the facility attendant must manually take down the shopper's information, including the shopper's name, phone number, the particular product the shopper desires to purchase, and any other pertinent information. This can result in an unorganized sum of requests that may not be attended to by the retailer in an efficient manner, and may result in the shopper never being notified when the particular product becomes available.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 schematically illustrates a notification server in communication with a mobile computing device displaying a graphical user interface in accordance with an exemplary embodiment of the present disclosure;

FIG. 2A-2F schematically illustrate non-limiting examples of generated notifications displayed on the graphical user interface of FIG. 1, in accordance with an exemplary embodiment of the present disclosure;

FIG. 3A-3B schematically illustrate non-limiting examples of a user discovering an item offered for sale by a retailer is currently unavailable, in accordance with an exemplary embodiment of the present disclosure;

FIG. 4 is a block diagram illustrating components of the mobile computing device of FIG. 1, in accordance with an exemplary embodiment of the present disclosure;

FIG. 5 is a block diagram illustrating components of the notification server of FIG. 1, in accordance with an exemplary embodiment of the present disclosure; and

FIG. 6 is a flowchart illustrating an example method for generating a notification, in accordance an exemplary embodiment of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. Techniques for generating a notification based on user information when a presence of the mobile computing device is detected in a facility are described herein. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

It may be desirable to notify users when products that were unavailable within a facility of a retailer during a recent trip, later become available within the facility. Notifying users when products being offered for sale by the retailer become available within the facility are described herein. The term “facility” can refer to shopping venues, complexes and department stores; the term “user” can refer to a potential consumer, customer or shopper at the facility; the term “product” can refer to groceries, foods, office supplies, clothing wares, or any other fungible goods sold by the retailer; and the term “promotion” can refer to sales, coupons, and events offered by the retailer. As used herein, the term “item identifier” can refer to any type of indicator of a product sold by a retailer such as a Universal Product Code (UPC).

Some users utilize the capabilities of their mobile computing devices to obtain and view information. For example, a user may obtain a generated notification transmitted from a notification server of the retailer when a product offered for sale by the retailer becomes available within a facility based on a request and user request information obtained by the notification server from the user. As used herein, the term “mobile computing device” can refer to mobile telephones, laptop computers, and tablet computers. The generated notifications can be displayed by the mobile computing devices for view by the intended users while shopping at the facility. The user can input a command causing the mobile computing device to perform one or more operations relating to the generated notification.

In accordance with various embodiments of the present disclosure, techniques are described for obtaining a request including user request information to notify the user when a product offered for sale by a retailer becomes available in a facility of the retailer when the mobile computing device scans a notification image. For example, the user may arrive at a display apparatus preferred for stocking the product, but the display apparatus may be sold out of the product. The mobile computing device can be used to scan the notification image, wherein the notification image corresponds to the product and may be located at a section of the facility preferred by the retailer for stocking the product, e.g., the display apparatus including a shelf or garment rack. Specifically, the act of scanning the notification image invokes the request including the user request information that is obtained by a notification server furnished by the facility. In one embodiment, the notification image is a Quick Response (QR) code. Other embodiments may include the notification image being indicative of a bar code or any graphical image capable of being scanned and invoking the request including the request information. The received user request information can include an item identifier corresponding to the product, e.g., a UPC. The item identifier may be embedded within the notification graphic. The received user request information can further include a user identifier corresponding to the user. In one embodiment, the mobile computing device provides the user identifier, e.g., a user name. In another embodiment, described in greater detail below, the user identifier may be input by the user through a uniform resource locator (URL). For instance the user identifier may include a mobile phone number corresponding to the user. The received user request information can further include facility information corresponding to the facility at which the notification image is scanned. In one embodiment, the facility information is indicative of information related to a facility identifier corresponding to the facility that is embedded within the notification image. The notification server may subsequently use the facility identifier to retrieve a location of the facility from a facility database. In another embodiment, the facility information is indicative of information related to a location of the facility obtained by the mobile computing device when the notification image is scanned. Accordingly, the user request information obtained by the notification server may be stored in a user request database.

In an exemplary embodiment, the notification server may receive the request including the user request information from the mobile computing device in response to the mobile computing device scanning the notification image. In this embodiment, the mobile computing device includes an application dedicated for interaction with the notification server and the user identifier, e.g, user name, is provided by the mobile computing device. It will be understood, that the request including the user request information is automatically broadcasted from the mobile computing device in response to the notification image being scanned. Accordingly, the user request information can be stored in the user request database.

In an alternative embodiment, the notification server may receive the request including the user request information from URL furnished by the retailer for interacting with the notification server. The URL is invoked by the mobile computing device in response to the mobile computing device scanning the notification image. The URL may be displayed in a graphical user interface of the mobile computing device. The URL may prompt the user to enter the user identifier, e.g., a mobile phone number. Subsequently, the URL may broadcast the request including the user request information to the notification server after the user enters the user identifier. For example, a user whose mobile computing device does not include an application for interacting with the notification server, may still request to be notified when a product becomes available within the facility by scanning the notification graphic and manually entering the user identifier through the URL. Thereafter, any notification(s) may be transmitted to the mobile computing device using the mobile phone number provided by the user.

Furthermore, techniques are described for generating a notification based on the user request information when the product becomes available within the facility. Generating the notification can be performed at a processing device of the notification server. The user request information can be retrieved from the user request database using a retrieving item identifier received by the processing device from a computing device corresponding to the retailer. The retrieving item identifier may correspond to the product and be indicative of the product being available within the facility. For example, a facility attendant stocking newly arrived products may record each of the products into an inventory database of the facility. Each of the newly arrived products may include a retrieving item identifier received by the processing device and input to a notification database. Subsequently, the processing device may query the item request database to retrieve the item request information having an item identifier that matches the retrieving item identifier. Thus, when a product becomes available in the facility that was previously unavailable during a recent visit by the user to the facility, the generated notification can be transmitted to the mobile computing device to notify the user that the product is available within the facility.

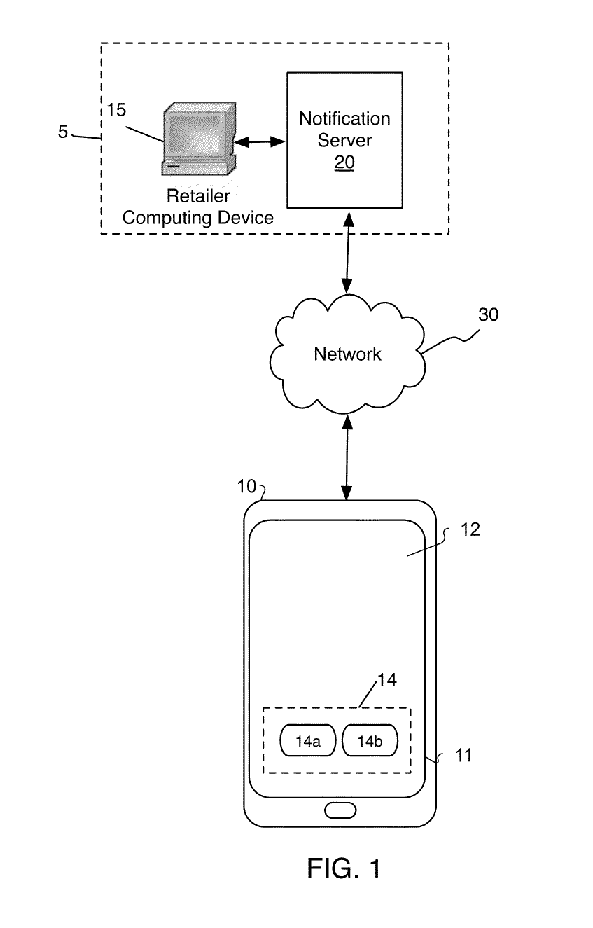

FIG. 1 illustrates a mobile computing device 10 in communication with a notification system 5 via network 30. The notification system 5 includes a notification server 20 and a retailer computing device 15. While one notification server 30 is illustrated, the term “notification server” refers to one or more servers that operate in an individual or distributed manner. While one retailer computing device 15 is illustrated, the term “retailer computing device” refers to one or more computing devices that operate to transmit one or more inputs to the notification server 20 for storing one or more notifications within a notification database. For instance, a facility manager can operate the retailer computing device 15 to send inputs to the notification server 20 to send notifications to users when products requested by the retailer become available within a facility. The retailer computing device 15 can be associated with one facility or the retailer computing device can be associated with a plurality of facilities. Further, as used herein, the term “network” can refer to any communication network including, but not limited to, a wireless network, a cellular network, an intranet, the Internet, or combinations thereof. In the illustrated example, the mobile computing device 10 is displaying a graphical user interface (GUI) 12 on a touch screen 11 of the mobile computing device 10. While a touch screen 11 is illustrated, it should be appreciated that other user interfaces can be used to allow a user to interact with the mobile computing device 10. The graphical user interface may display at least one operational input 14, e.g., push buttons 14a and 14b, that allows the user to provide a command to the mobile computing device 10, the command causing the mobile computing device 10 to perform one or more operations.

The notification server 20 may include a processing device that obtains a request including user request information to notify the user when a product offered for sale by a retailer becomes available in a facility of the retailer when the mobile computing device scans a notification image. The user request information obtained by the processing device is stored in a user request database. The user request information includes an item identifier corresponding to the product. The item identifier may be embedded within the notification image and obtained upon scanning the notification image. Additionally, the user request information may further include facility information corresponding to the facility. Furthermore, the user request information can include a user identifier, e.g., a user name or mobile phone number, corresponding to the user. When the product becomes available within the facility, the processing device can retrieve the user request information from the user request database, e.g., using a retrieving item identifier, generate a notification based on the user request information and transmit the generated notification to the mobile computing device 10 via the network 30. The generated notifications can include, but are not limited to, availability notifications, interactive notifications, or any combination thereof, transmitted to the mobile computing device 10.

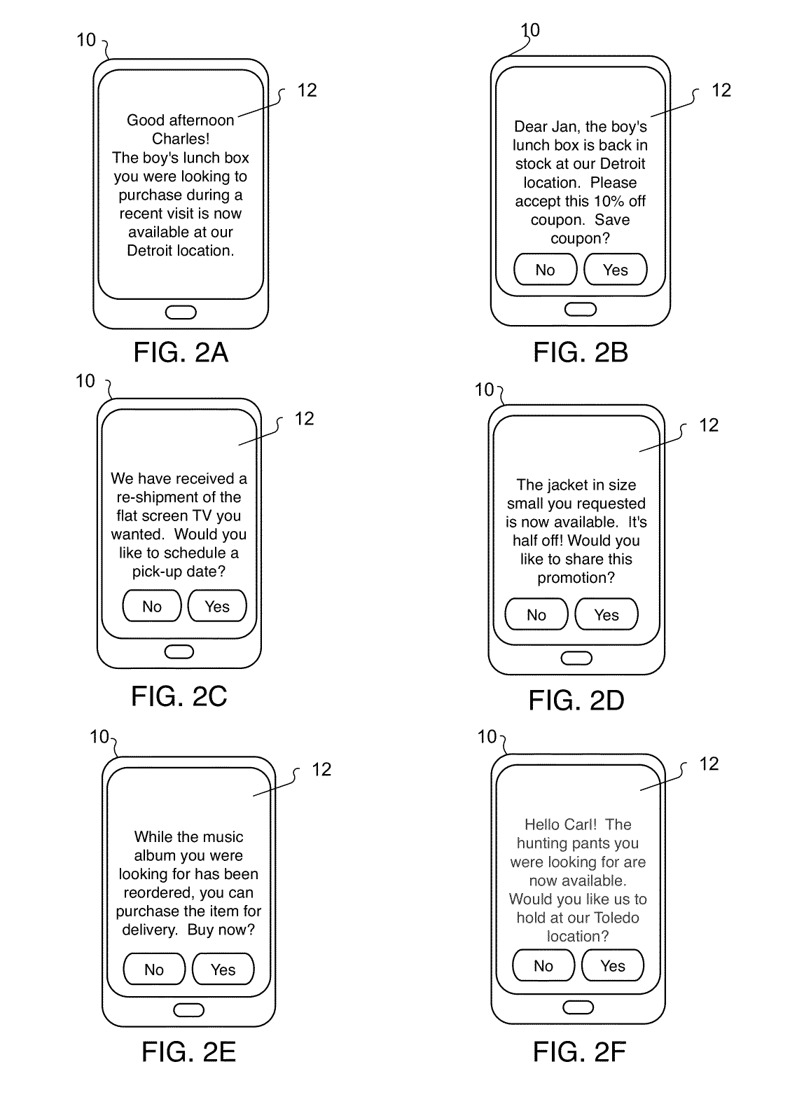

FIGS. 2A-2F illustrate non-limiting examples of notifications displayed on the GUI 12 of the mobile computing device 10. It will be understood that the displayed notifications are not limited to any size or shape. Embodiments are envisioned where the notification can first be displayed as a smaller graphical feature such as a banner displayed on a portion of the GUI 12 that can be enlarged upon a user input, e.g., tapping, to expand the size of the banner.

In one embodiment, the generated notification transmitted to the mobile computing device 10 can include an availability notification. The availability notification is provided to a mobile computing device corresponding to a user when a product becomes available within a facility of a retailer, wherein the user previously requested to be notified when the product becomes available within the facility. In some embodiments, the availability notification can be indicative of a description of the product and a location of the facility at which the product is currently available for purchase. Here, the description of the product can be retrieved from a product database using an item identifier retrieved from a user request database. Similarly, the location of the facility can be retrieved from a facility database using a facility identifier obtained from facility information corresponding to the facility and stored in a facility database. FIG. 2A illustrates a non-limiting example of an availability notification informing a user that an item is available, the availability notification providing a description of the product and a location of the facility at which the product is currently available for purchase.

In another embodiment, the generated notification transmitted to the mobile computing device 10 can include an interactive notification. The interactive notification may inform the user that the product is currently available for purchase within the facility and may prompt the mobile computing device to display an interactive graphic in the GUI 12. The interactive graphic may display information related to at least one of a promotion related to the product and an inquiry related to the product requested by the retailer. The term “inquiry” can refer to a question, query, survey or demand requested by the retailer that solicits a response from the user. The interactive graphic allows the user to provide a command to the mobile computing device to perform one or more operations relating to at least one of the promotion and the inquiry. In one embodiment, the user can provide the command via operational inputs 14a and 14b of FIG. 1 including “one-tap” yes and no push buttons. Alternatively, the user may provide the command via any other operational inputs including, but not limited to, a speech input, gesturing and shaking the mobile computing device. FIG. 2B illustrates a non-limiting example of the interactive graphic informing the user of the availability of a product within a facility and displaying information related to a promotion offered by the retailer and an inquiry requested by the retailer, e.g., an inquiry requesting if the user desires to save a promotional coupon corresponding to the product. The user may command the mobile computing device 10 to save the coupon within a memory device of the mobile computing device 10 via an operational input. Alternatively or additionally, the electronic coupon may be stored in a remote memory device accessible by the user. In the non-limiting example of FIG. 2B, the facility may provide this promotion to restore facility recognition due to the product previously being out of stock. Similarly, the facility may provide this promotion if it was previously offered when the user came to the facility to purchase the product, but the item was out of stock. Hence, the generated notification including the promotion may serve as a rain check to purchase the item. In one embodiment, the electronic coupon can be an expiring coupon that can only be redeemed by the user within a predetermined time period. For example, the electronic coupon may expire within a few days to encourage the user to come to the facility. In another example, the electronic coupon may only remain accessible within the memory device of the mobile computing device for one week

FIG. 2C illustrates a non-limiting example of the interactive graphic informing the user of the availability of a product within a facility and displaying information related to an inquiry requested by the retailer, e.g., if the user would like to schedule a pick-up date to purchase the product. The user may command the mobile computing device 10 to schedule a date to pick up the product from the facility and further save the pick-up date in an electronic calendar corresponding to the user. FIG. 2D illustrates a non-limiting example of the interactive graphic informing the user of the availability of a product within a facility and displaying information related to a promotion related to the product and an inquiry requested by the retailer, e.g., if the user would like to share the promotion corresponding the product being half off. The user may command the mobile computing device 10 to share the generated notification to another user via an operational input. Sharing can include, but is not limited to, transmitting an electronic message including the promotion to at least one other user and broadcasting the promotion over a social network.

FIG. 2E illustrates a non-limiting example of the interactive graphic informing the user of the availability of a product within a facility and displaying information related to an inquiry requested by the retailer, e.g., if the user would like to purchase the product. The user may command the mobile computing device 10 to purchase the product and have the item delivered to the user. FIG. 2F illustrates a non-limiting example of the interactive graphic informing the user of the availability of a product within the facility and display information related to an inquiry requested by the retailer, e.g., if the user would like the facility to hold the item for the user. The user may command the mobile computing device 10 to request that the facility hold the product until the user comes to the facility to purchase the product. It will be appreciated that this notification may be generated if the item is low on stock and/or is anticipated to sell-out soon.

The examples of FIGS. 2A-2F are provided for example only and not intended to be limiting. It will be appreciated that the generated notification is not limited to one type or classification, but each generated notification may include any combination of the availability interactive notifications transmitted to the mobile computing device and based on user information request when the product requested by the user becomes available within the facility. Furthermore, variations of the GUI 12 are contemplated and are within the scope of the disclosure.

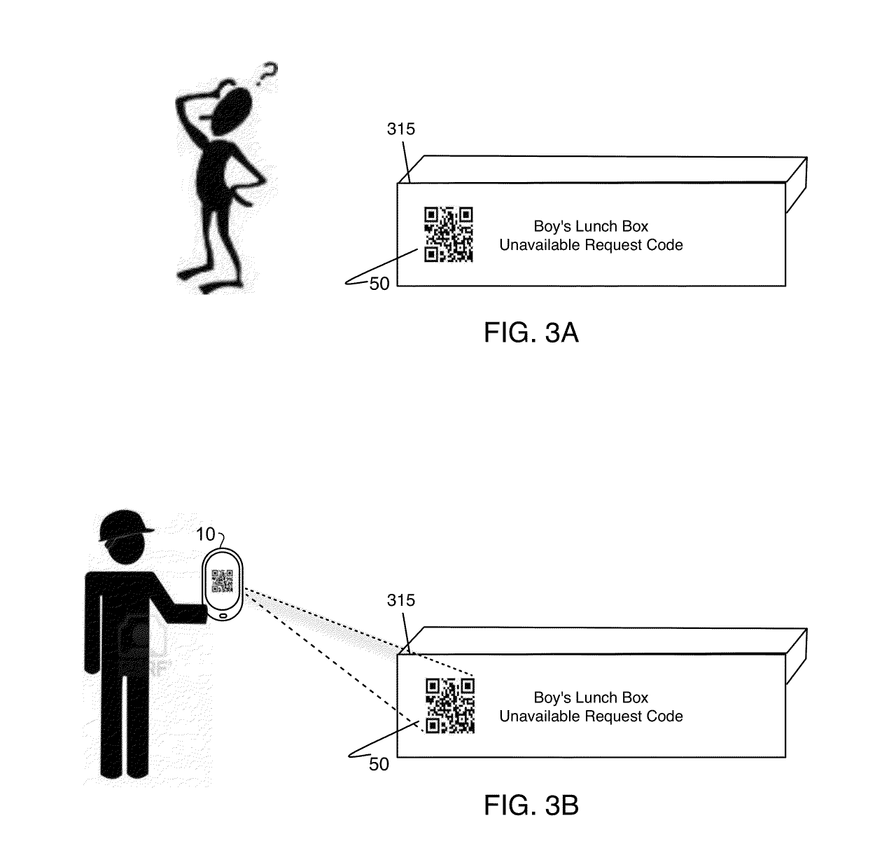

FIG. 3A-3B schematically illustrate non-limiting examples of a user discovering an item offered for sale by a retailer is currently unavailable, in accordance with an exemplary embodiment of the present disclosure. FIGS. 3A and 3B schematically illustrate a display apparatus corresponding to a shelf apparatus 315. A notification image including a quick response (QR) code 50 is illustrated that corresponds to a product preferred by the retailer for being stocked at the shelf apparatus 315. The QR code 50 is described as an “unavailable request code” corresponding to a boy's lunch box offered for sale by the retailer.

As illustrated in the non-limiting example of FIG. 3A, a user within a facility may arrive at the shelf apparatus 315 with the intention of purchasing the boy's lunch box. However, the user discovers that the boy's lunch box is currently sold out, and thus, unavailable. Referring to the non-limiting example of FIG. 3B, the user may use a mobile computing device 10 to scan the QR code 50. Accordingly, a request including user request information to notify the user when the product, e.g., boy's lunch box, becomes available in the facility when the mobile computing device 50 scans the notification image, e.g., QR code 50, can be obtained by a notification server. In one example, a user identifier can be broadcasted from the mobile computing device in response to scanning the QR code 50, and included as the user information. In another example, the user identifier can be manually input by the user when a URL furnished by the facility prompts the user to do so using a graphical user interface within the mobile computing device 10, wherein the URL is invoked in response to the QR code 50 being scanned. In yet another example, a facility identifier embedded within the QR code 50 can be obtained by the mobile computing device 10 and broadcasted to the notification server. Similarly, a location of the facility can be obtained by the mobile computing device 10 when the QR code 50 is scanned. The location of the facility can be broadcasted to the notification server. In yet another example, an item identifier can be broadcasted from the mobile computing device 10, wherein the item identifier, e.g., UPC, is embedded within the QR code 50.

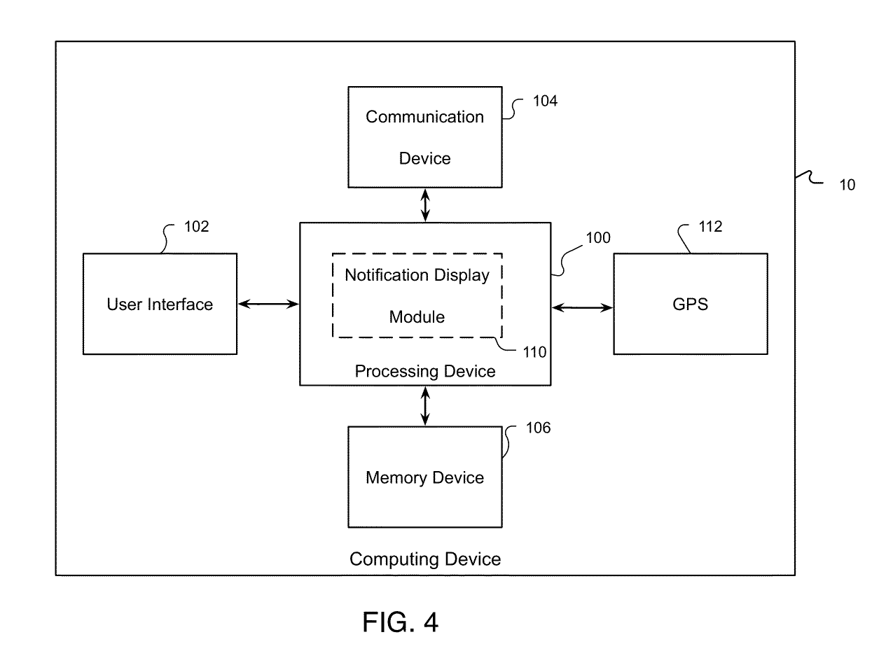

Referring now to FIG. 4, a block diagram illustrating example components of the mobile computing device 10 of FIG. 1 is depicted. In the example embodiment, the mobile computing device 10 includes a processing device 100, a user interface 102, a communication device 104, a memory device 106 and a GPS device 112.

The processing device 100 can include memory, e.g., read only memory (ROM) and random access memory (RAM), storing processor-executable instructions and one or more processors that execute the processor-executable instructions. In embodiments where the processing device 100 includes two or more processors, the processors can operate in a parallel or distributed manner. The processing device 100 can execute the operating system of the computing device. In the illustrative embodiment, the processing device 100 also includes a notification display module 110 for displaying a notification transmitted from the notification server 20 of FIG. 1. The notification display module 110 may provide the interface graphic in the GUI 102 and allow the user to provide the command to the mobile computing device to execute one or more operations relating to the interface graphic. In some embodiments, the notification display module 110 may provide a URL in the GUI 102 and allow the user to provide a user identifier, e.g., mobile phone number.

The user interface 102 is a device that allows a user to interact with the computing device 10. While one user interface 102 is shown, the term “user interface” can include, but is not limited to, a touch screen, a physical keyboard, a mouse, a microphone, and/or a speaker. The communication device 104 is a device that allows the mobile computing device 10 to communicate with another device, e.g., the notification server 20, via the network 30. The communication device 104 can include one or more wireless transceivers for performing wireless communication and/or one or more communication ports for performing wired communication. The memory device 106 is a device that stores data generated or received by the computing device 10. The memory device 106 can include, but is not limited to a hard disc drive, an optical disc drive, and/or a flash memory drive. The memory device 106 can include storage for an electronic calendar corresponding to the mobile computing device 10. The GPS device 112 can provide a location of the mobile computing device 10. The location of the mobile computing device 10 can correspond to a location of a facility when the mobile computing device scans a notification image corresponding to an unavailable image.

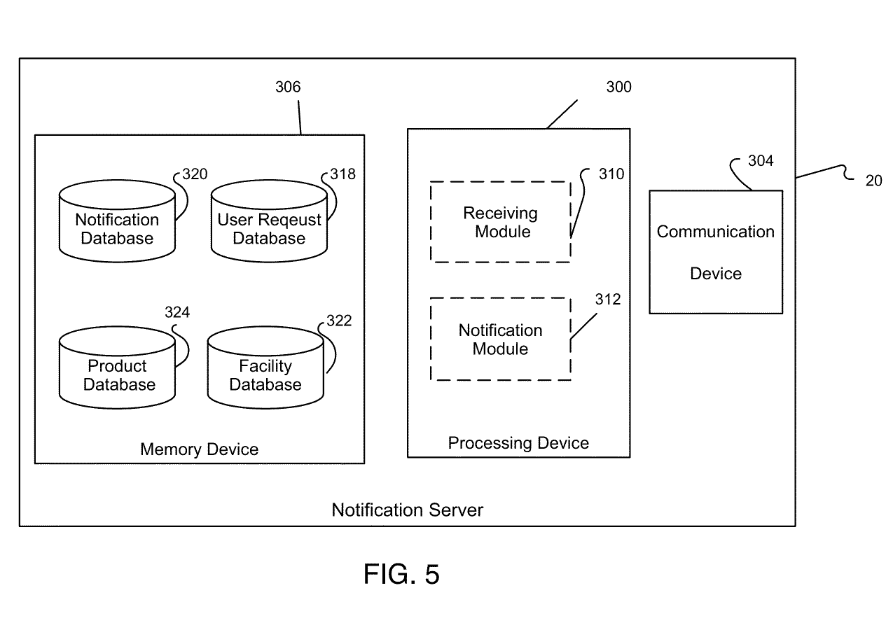

Referring now to FIG. 5, a block diagram illustrating an exemplary notification server 20 is depicted. In an exemplary embodiment, the notification server 20 includes a processing device 300, a communication device 304, and memory device 306.

The processing device 300 can include memory, e.g., read only memory (ROM) and random access memory (RAM), storing processor-executable instructions and one or more processors that execute the processor-executable instructions. In embodiments where the processing device 300 includes two or more processors, the processors can operate in a parallel or distributed manner. In the illustrative embodiment, the processing device 300 executes a receiving module 310 and a notification module 312, which are described in greater detail below.

The receiving module 310 obtains a request including user request information to notify the user when a product offered for sale by a retailer becomes available in a facility of the retailer. In one embodiment, the receiving module 310 receives the request including the user request information from the mobile computing device in response to the mobile computing device scanning a notification image, e.g., QR code. Here, the mobile computing device includes an application dedicated to the notification server 20, wherein a user identifier, e.g., user name, included in the user request information is broadcasted from the mobile computing device to the receiving module. In another embodiment, the request including the user request information is broadcasted from a URL furnished by the retailer that is invoked by the mobile computing device in response to the mobile computing device scanning the notification image. In this embodiment, the URL may be displayed in the GUI of the mobile computing device, prompt the user to enter the user identifier and subsequently broadcast the request including the user request information to the processing device upon the user entering the user identifier, wherein the user identifier includes a mobile phone number corresponding to the user. The receiving module 310 may then store the user request information in a user request database 318.

The notification module 312 retrieves the user request information from the user request database 318 when the product becomes available within the facility. Specifically, the notification module 312 retrieves the user request information by receiving a retrieving item identifier from a computing device corresponding to the retailer (e.g., retailer computing device 15 of FIG. 1), the retrieving item identifier corresponding to the product and indicative of the product being available within the facility. Thereafter, the notification module 312 retrieves the user request information from the user request database 318 using the retrieving item identifier, e.g., the retrieving item identifier corresponds to the item identifier included within the user request information. The notification module 312 further generates a notification based on the user request information. The generated notification can include any combination of an availability notification and an interactive notification discussed above in the non-limiting examples of FIGS. 2A-2F. The notification module 312 subsequently transmits the generated notification to the mobile computing device 10.

The communication device 304 is a device that allows the notification server 20 to communicate with another device, e.g., the mobile computing device 10, via the network 20. The communication device 304 can include one or more wireless transceivers for performing wireless communication and/or one or more communication ports for performing wired communication.

The memory device 306 is a device that stores data generated or received by the notifications server 20. The memory device 306 can include, but is not limited to, a hard disc drive, an optical disc drive, and/or flash memory drive. Further, the memory device 306 may be distributed and located at multiple locations. The memory device 306 is accessible to the processing device 300.

The user request database 318, or similar structure, can be stored in the memory device 306. In an exemplary embodiment, the user request information stored in the memory device 306 can include the user identifier, e.g., user name or mobile phone number, corresponding to the user, facility information corresponding to the facility and the item identifier corresponding to the product. In one embodiment, the facility information is indicative of information related to a facility identifier corresponding to the facility, wherein the facility identifier is embedded within the notification image and broadcasted from the mobile computing device. In another embodiment, the facility information is indicative of a location of the facility obtained by the mobile computing device when the mobile computing device scans the notification image. Further, the item identifier can include a UPC that is embedded within the notification image and obtained by scanning the notification image. The notification module 312 retrieves the user request information stored in the user request database 318 for generating a notification. For instance, the item identifier and the facility information can be retrieved from the user request database 318 to identify the product requested by the user and the facility at which the user desires to purchase the product. Accordingly, the user identifier can be retrieved by the notification module 312 from the user request database 318 to identify the mobile computing device for transmission of the generated notification.

Additionally, a notification database 320, or similar structure, can be stored in the memory device 306. In an exemplary embodiment, the retailer maintains the notification database 320 to input and store notifications. For instance, a facility manager may input notifications indicative of information related the availability of a product offered for sale by the retailer for storage in the notification database 320 via the retailer computing device 15 of FIG. 1. For example, when the product includes a garment, the retailer may desire that the notification always include a size of the garment. Likewise, a facility manager may input interactive notifications indicative of information related to at least one of a promotion related to the product and an inquiry related to the product requested by the retailer for storage in the notification database 320 via the retailer computing device 15 of FIG. 1. For example, the retailer may honor a promotion related to the product offered by the retailer at the time when the product was previously unavailable but has now become available. The notification module 312 retrieves a notification stored in the notification database 320 for generating a notification. Non-limiting examples of notifications stored in the notification database 320 are illustrated in FIGS. 2A-2F above.

Additionally, a facility database 322, or similar structure, can be stored in the memory device 306. In an exemplary embodiment, the retailer maintains the facility database to store locations for a plurality of facilities. When the user request information stored in the user request database includes a facility identifier, the facility identifier can be used by the notification module 312 to retrieve the location of the facility from the facility database 322. The notification module 312 uses the location of the facility stored in the facility database 322 for generating the notification. For instance, the generated notification can include the city and/or address of the facility where the product is currently available for purchase. It will be understood that when the user request information stored in the user request database 318 already includes the location of the facility, the notification module 312 simply uses the location of the facility stored in the user request database 318 for generating the notification.

Additionally, a product database 324, or similar structure, can be stored in the memory device 306. In an exemplary embodiment, the retailer maintains the product database 324 to store product information for a plurality of products offered by the retailer. The product information may be indicative of information relating to a description of the product and any promotions offered by the retailer relating to the product. For instance, a facility manager may input a description of a product corresponding to an item identifier, e.g., UPC, for storage in the product database 324 via the retailer computing device 15 of FIG. 1. Likewise, a facility manager may input any promotions being offered by the retailer relating to the product for storage in the product database 324 via the retailer computing device 15 of FIG. 1.

In an exemplary embodiment, the retailer maintains the notification server 20, such that the user request information stored in the user request database 318, the notifications stored in the notification database 320, the location of the facility stored in the facility database 322, and product information relating to the product can be queried and retrieved by the notification module 312 to generate and transmit a notification to the mobile computing device 10. The notification module 310 can query each of the user request database 318, the notification database 320, the facility database 322 and the product database 324 to obtain pertinent information for generating a notification and transmitting the notification to the mobile computing device 10 of FIG. 1. For instance, the notification module 310 can obtain a description of a product from the product database 322 using an item identifier stored in the user request database 318. Similarly, the notification module 310 can obtain a promotion being offered by the retailer related to the product from the product database 322 and retrieve an interactive notification from the notification database 320 indicative of the promotion related to the product obtained from the product database 322. Alternatively, a third party or a party affiliated with the retailer, can maintain the notification server 20.

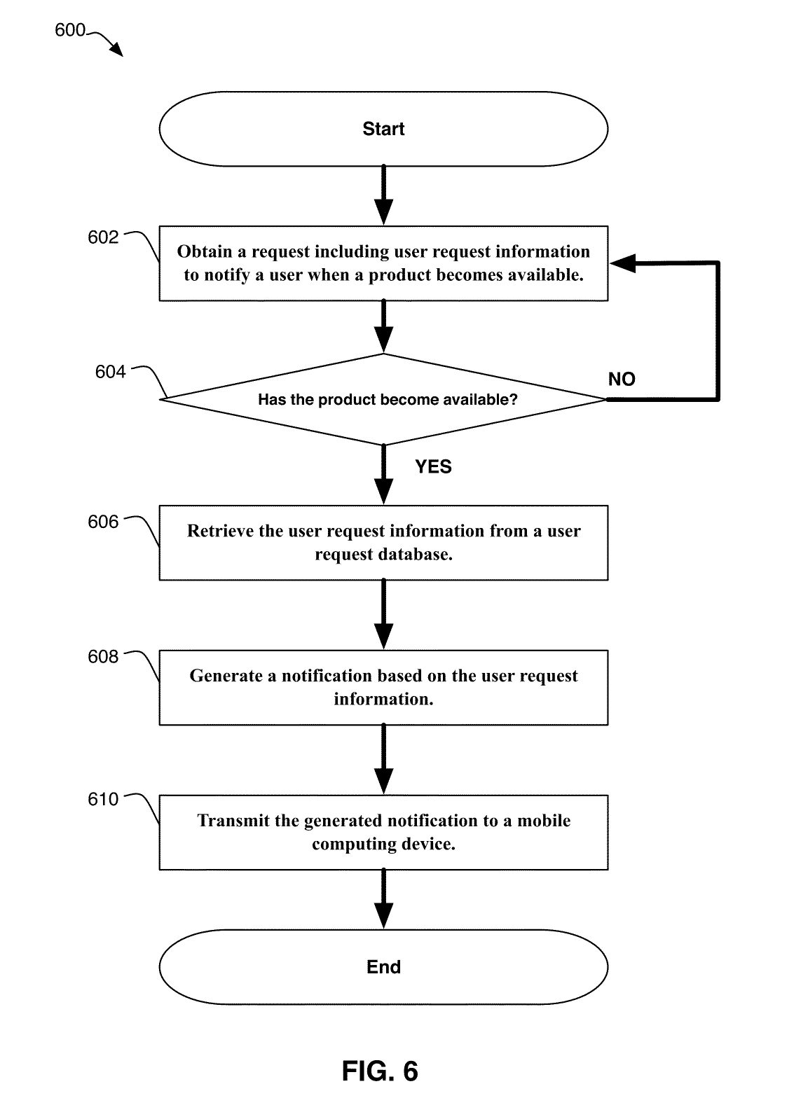

FIG. 6 illustrates an example method of a flowchart 600 that can be executed by the notification server 20 for generating and sending a notification from the notification server 20 to the mobile computing device 10 corresponding to a user. At operation 602, the receiving module 310 obtains a request including user request information to notify a user when a product becomes available for purchase within a facility of a retailer. In one embodiment, the request including the user request information can be broadcasted directly from the mobile computing device 10 in response to the mobile computing device scanning a notification image, e.g., QR code, corresponding to the product. In another embodiment, the request including the user request information can be broadcasted from a uniform resource locator (URL) furnished by the retailer that is invoked by the mobile computing device in response to the mobile computing device scanning the notification image. The URL may be displayed in the GUI of the mobile computing device. Subsequently, the receiving module 310 stores the user request information in the user request database 318.

At operation 604, a decision is made on whether the product has become available within the facility. If the product remains unavailable within the facility, the flowchart 600 iteratively reverts back to operation 602. If the product becomes available within the facility, the flowchart 600 iteratively proceeds to operation 606. In an exemplary embodiment, the product becomes available within the facility when a retrieving item identifier is input to the notification server from the retailer computing device 15. For instance, the retrieving item identifier corresponds to the product and is indicative of the product being available within the facility. At operation 606, the notification module 312 retrieves the user request information from the user request database 318 using the retrieving item identifier. For instance, the retrieving item identifier is matched with the item identifier included within the user request information in order to retrieve the user request information from the user request database 318.

At operation 608, the notification module 312 generates a notification based on the user request information retrieved from the user request database 318. In an exemplary embodiment, the generated notification informs the user that the product is now available within the facility and may include product information relating to the product and the location of the facility. For instance, the notification module 312 may retrieve the product information from the product database 324 using the item identifier obtained from the user request database 318, wherein the product information may be indicative of information relating to a description of the product and any promotions offered by the retailer relating to the product. Likewise, the notification module 312 may retrieve the location of the facility from the facility database 322. In another embodiment, the location of the facility may be obtained directly from the user request database 318 when the facility information included within the user request information already includes the location of the facility that was obtained by the mobile computing device upon scanning the notification image. In an exemplary embodiment, a facility and/or regional manager can input notifications within the notification database 320 as new promotions obtained from the product database 324 and relating to the product arise. In one embodiment, the generated notification can include an availability notification described with reference to FIG. 2A. In another embodiment, the generated notification can include an interactive notification described with reference to FIGS. 2B-2F. It will be appreciated that the generation notification can include any combination of the available and interactive notifications. For instance, in a non-limiting example, a combination of an available and interactive notification may be generated informing the user that a boy's lunch box is now available within the facility and offering a 10% off electronic coupon, wherein the mobile computing device 10 is prompted to display an interactive graphic in a GUI of the mobile computing device to allow the user to command storing the electronic coupon. Accordingly, the notification module 312 may obtain the user request information stored in the user request database 318, the notifications stored in the notification database 320, the location of the facility stored in the facility database 322, and product information relating to the product can be retrieved by the notification module 312 to generate the notification.

At operation 610, the notification module 312 transmits the generated notification to the mobile computing device 12. In one embodiment, the generated notification is additionally or alternatively broadcasted to an email address corresponding to the user. Upon receiving the generated notification, the notification display module 110 of the mobile computing device 10 can display the generated notification upon the GUI 12. If the notification is an interactive notification displaying an interactive graphic, the user may provide a command to the mobile computing device via one or more operational inputs 14 displayed on the GUI causing the mobile computing device 10 to perform one or more operations relating to the interactive notification.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

What is claimed is:

1. A method for sending a notification from a notification server to a mobile computing device corresponding to a user, comprising:
obtaining, at a processing device of the notification server, a request including user request information to notify the user when a product offered for sale by a retailer becomes available in a facility of the retailer when the mobile computing device scans a notification image, the user request information including,
a. an item identifier corresponding to the product, the item identifier embedded within the notification image,
b. facility information corresponding to the facility, and
c. a user identifier corresponding to the user;
when the product becomes available in the facility:
a. retrieving, at the processing device, the user request information from a user request database;
b. generating, at the processing device, the notification based on the user request information; and
c. transmitting, at the processing device, the generated notification to the mobile computing device.

2. The method of claim 1, wherein the notification image includes a quick response code corresponding to the product, the quick response code located in a section of the facility preferred by the retailer for stocking the product.

3. The method of claim 1, wherein the user request information including the facility information is indicative of information related to a facility identifier corresponding to the facility that is embedded within the notification image and broadcasted from the mobile computing device.

4. The method of claim 1, wherein the user request information including the facility information is indicative of information related to a location of the facility obtained by the mobile computing device when the notification image is scanned.

5. The method of claim 1, wherein obtaining the request including the user request information includes:
receiving, at the processing device, the request including the user request information from the mobile computing device in response to the mobile computing device scanning the notification image, wherein the user identifier is broadcasted from the mobile computing device; and
storing, at the processing device, the user request information in the user request database, the user request database storing user request information for a plurality of users.

6. The method of claim 1, wherein obtaining the request including the user request information includes:
receiving, at the processing device, the request including the user request information from a uniform resource locator furnished by the retailer that is invoked by the mobile computing device in response to the mobile computing device scanning the notification image, the uniform resource locator prompting the user to enter the user identifier and subsequently broadcast the request including the user request information to the processing device upon the user entering the user identifier, wherein the user identifier includes a mobile phone number corresponding to the user; and
storing, at the processing device, the user request information in the user request database, the user request database storing user request information for a plurality of users.

7. The method of claim 1, wherein retrieving the user request information from the user request database includes:
receiving, at the processing device, a retrieving item identifier from a computing device corresponding to the retailer, the retrieving item identifier corresponding to the product and indicative of the product being available within the facility; and
retrieving, at the processing device, the user request information from the user request database using the retrieving item identifier.

8. The method of claim 1, further comprising:
retrieving, at the processing device, product information corresponding to the product from a product database using the item identifier, wherein the product database stores product information for a plurality of products; and
retrieving, at the processing device, a location of the facility from a facility database using a facility identifier obtained from the facility information, the facility database storing locations for a plurality of facilities, wherein the generated notification is based on the product information and the location of the facility.

9. The method of claim 1, wherein the notification is an availability notification informing the user that the product is currently available for purchase within the facility, the availability notification being indicative of a description of the product and a location of the facility at which the product is currently available for purchase.

10. The method of claim 1, wherein the notification is an interactive notification informing the user that the product is currently available for purchase within the facility, the interactive notification prompting the mobile computing device to display an interactive graphic in a graphical user interface of the mobile computing device, wherein the interactive graphic displays information related to at least one of a promotion related to the product and an inquiry related to the product requested by the retailer and allows the user to provide a command to the mobile computing device, the command causing the mobile computing device to perform one or more operations relating to the at least one of the promotion and the inquiry.

11. The method of claim 10, wherein the command causes the mobile computing device to perform at least one of:
a. store an electronic coupon in a memory device of the mobile computing device, the electronic coupon being indicative of the promotion related to the product,
b. add an event to an electronic calendar corresponding to the user, the event being indicative of a pick-up date to purchase the product,
c. share the promotion with another user,
d. purchase the product, and
e. request the facility to hold the product.

12. A notification server that sends notifications to a mobile computing device corresponding to a user, the server comprising:
a receiving module that obtains a request including user request information to notify the user when a product offered for sale by a retailer becomes available in a facility of the retailer when the mobile computing device scans a notification image, the user request information including
a. an item identifier corresponding to the product, the item identifier embedded within the notification image,
b. facility information corresponding to the facility, and
c. a user identifier corresponding to the user; and
a notification module, that in response to the product becoming available within the facility
a. retrieves the user request information from a user request database;
b. generates the notification based on the user request information; and
c. transmits the generated notification to the mobile computing device.

13. The notification server of claim 12, wherein the notification image includes a quick response code corresponding to the product, the quick response code located in a section of the facility preferred by the retailer for stocking the product.

14. The notification server of claim 12, wherein the facility information received by the receiving module is indicative of information related to a facility identifier corresponding to the facility, the facility identifier is embedded within the notification image and broadcasted from the mobile computing device.

15. The notification server of claim 12, wherein the facility information received by the receiving module is indicative of information related to a location of the facility obtained by the mobile computing device when the notification image is scanned.

16. The notification server of claim 12, wherein the receiving module obtains the request including the user request information by
receiving the request including the user request information from the mobile computing device in response to the mobile computing device scanning the notification image, wherein the user identifier is broadcasted from the mobile computing device; and
storing the user request information in a user request database, the user request database storing user request information for a plurality of users.

17. The notification server of claim 12, wherein the receiving module obtains the request including the user request information by
receiving the request including the user request information from a uniform resource locator furnished by the retailer that is invoked by the mobile computing device in response to the mobile computing device scanning the notification image, the uniform resource locator prompting the user to enter the user identifier and subsequently broadcast the request including the user request information to the processing device upon the user entering the user identifier, wherein the user identifier includes a mobile phone number corresponding to the user; and
storing the user request information in a user request database, user request database storing user request information for a plurality of users.

18. The notification server of claim 12, wherein the notification module retrieves the user request information from the user request database by
receiving a retrieving item identifier from a computing device corresponding to the retailer, the retrieving item identifier corresponding to the product and indicative of the product being available within the facility; and
retrieving the user request information from the user request database using the retrieving item identifier.

19. The notification server of claim 12, wherein the notification module, that in response to the product becoming available within the facility further
retrieves product information corresponding to the product from a product database using the item identifier, the product information indicative of information relating to a description of the product and any promotions offered by the retailer relating to the product, wherein the product database stores product information for a plurality of products; and
retrieves a location of the facility from a facility database using a facility identifier obtained from the facility information, the facility database storing locations for a plurality of facilities, wherein the generated notification is based on the product information and the location of the facility.

20. The notification server of claim 12, wherein the notification is an availability notification informing the user that the product is currently available for purchase within the facility, the availability notification being indicative of a description of the product and a location of the facility at which the product is currently available for purchase.

21. The notification server of claim 12, wherein the notification is an interactive notification informing the user that the product is currently available for purchase within the facility, the interactive notification prompting the mobile computing device to display an interactive graphic in a graphical user interface of the mobile computing device, wherein the interactive graphic displays information related to at least one of a promotion related to the product and an inquiry related to the product requested by the retailer and allows the user to provide a command to the mobile computing device, the command causing the mobile computing device to perform one or more operations relating to the at least one of the promotion and the inquiry.

22. The notification server of claim 21, wherein the command causes the mobile computing device to perform at least one of:
a. store an electronic coupon in a memory device of the mobile computing device, the electronic coupon being indicative of the promotion related to the product,
b. add an event to an electronic calendar corresponding to the user, the event being indicative of a pick-up date to purchase the product,
c. share the promotion with another user,
d. purchase the product, and
e. request the facility to hold the product.
